(19) United States
(12) Patent Application Publication
(10) Pub. No.: US 2021/0141926 A1
(43) Pub. Date: May 13, 2021

(54) Enabling the Sharing of Privacy-safe Data with Deep Poisoning Functions

(71) Applicant: Facebook, Inc., Menlo Park, CA (US)

(72) Inventors: Cristian Canton Ferrer, Sammamish, WA (US); Brian Dolhansky, Seattle, WA (US); Hao Guo, Seattle, WA (US); Eric Erkon Hsin, Seattle, WA (US); Phong Dinh, Redmond, WA (US)

(21) Appl. No.: 16/790,437

(22) Filed: Feb. 13, 2020

Related U.S. Application Data
(63) Continuation of application No. 62/934,963, filed on Nov. 13, 2019.

(51) Int. Cl. G06F 21/62; G06K 9/62; G06K 9/00; G06N 3/08; G06N 20/20

(52) U.S. Cl. CPC G06F 21/6245; G06K 9/6256; G06K 9/00288; G06N 3/08; G06N 20/20; G06K 9/00275

(57) ABSTRACT

In one embodiment, a method includes accessing a first machine-learning model trained to generate a feature representation of an input data, a second machine-learning model trained to generate a desired result based on the feature representation, and a third machine-learning model trained to generate an undesired result based on the feature representation, and training a fourth machine-learning model by generating a secured feature representation by processing a first output of the first machine-learning model using the fourth machine-learning model, generating a second output and a third output by processing the secured feature representation using, respectively, the second and third machine-learning models, and updating the fourth machine-learning model according to an optimization function configured to optimize a correctness of the second output and an incorrectness of the third output.

### PRIORITY

This application claims the benefit under 35 U.S.C. § 119(e) of U.S. Provisional Patent Application No. 62/934963, filed 13 Nov. 2019, which is incorporated herein by reference.

### TECHNICAL FIELD

This disclosure generally relates to databases and file management within network environments, and in particular relates to machine learning for such management.

### BACKGROUND

Machine learning (ML) is the study of algorithms and mathematical models that computer systems use to progressively improve their performance on a specific task. Machine learning algorithms build a mathematical model of sample data, known as “training data”, in order to make predictions or decisions without being explicitly programmed to perform the task. Machine learning algorithms may be used in applications such as email filtering, detection of network intruders, and computer vision, where it is difficult to develop an algorithm of specific instructions for performing the task. Machine learning is closely related to computational statistics, which focuses on making predictions using computers. The study of mathematical optimization delivers methods, theory, and application domains to the field of machine learning. Data mining is a field of study within machine learning and focuses on exploratory data analysis through unsupervised learning. In its application across business problems, machine learning is also referred to as predictive analytics.

Internet privacy involves the right or mandate of personal privacy concerning the storing, repurposing, provision to third parties, and displaying of information pertaining to oneself via the Internet. Internet privacy is a subset of data privacy. Privacy concerns have been articulated from the beginnings of large-scale computer sharing. Privacy may entail either Personally Identifying Information (PII) or non-PII information such as a site visitor's behavior on a website. PII refers to any information that may be used to identify an individual.

### SUMMARY OF PARTICULAR EMBODIMENTS

As deep networks are applied to an ever-expanding set of tasks, protecting general privacy in data files has become a critically important goal. As an example and not by way of limitation, these tasks may be computer vision tasks and the data files may be images. The embodiments disclosed herein present a new framework for privacy-preserving data sharing that is robust to adversarial attacks and overcomes the known issues existing in previous approaches. The embodiments disclosed herein introduce the concept of a Deep Poisoning Function (DPF), which is a module inserted into a pre-trained deep network designed to perform a specific vision task. In particular embodiments, the DPF may be optimized to deliberately poison image data to prevent known adversarial attacks, while ensuring that the altered image data is functionally equivalent to the non-poisoned data for the original task. Given this equivalence, both poisoned and non-poisoned data may be used for further retraining or fine-tuning. Experimental results on image classification and face recognition tasks prove the efficacy of the embodiments disclosed herein.

In particular embodiments, a computing system may access a first machine-learning model trained to generate a feature representation of an input data. The computing system may also access a second machine-learning model trained to generate a desired result based on the feature representation. The computing system may additionally access a third machine-learning model trained to generate an undesired result based on the feature representation. In particular embodiments, the computing system may further train a fourth machine-learning model by the following process. The computing system may first generate a secured feature representation by processing a first output of the first machine-learning model using the fourth machine-learning model. The computing system may then generate a second output and a third output by processing the secured feature representation using, respectively, the second and third machine-learning models. The computing system may further update the fourth machine-learning model according to an optimization function configured to optimize a correctness of the second output and an incorrectness of the third output.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, may be claimed in another claim category, e.g. system, as well. The dependencies or references back in the attached claims are chosen for formal reasons only. However any subject matter resulting from a deliberate reference back to any previous claims (in particular multiple dependencies) may be claimed as well, so that any combination of claims and the features thereof are disclosed and may be claimed regardless of the dependencies chosen in the attached claims. The subject-matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim and/or in any combination with any embodiment or feature described or depicted herein or with any of the features of the attached claims.

### BRIEF DESCRIPTION OF THE DRAWINGS

FIG. 1 illustrates an example framework for protecting intermediate convolutional features.

FIG. 2 illustrates an example initial training of a classification model and an associated reconstruction process.

FIG. 3 illustrates example information contained in convolutional features.

FIG. 4 illustrates an example training process of the deep poisoning function and associated uses cases for sharing data and pre-trained models.

FIG. 5 illustrates example image reconstruction results.

FIG. 6 illustrates example comparisons of image reconstruction from the original convolutional features and the poisoned convolutional features.

FIG. 7 illustrates example reconstruction results from the original and poisoned convolutional features by reconstructors.

FIG. 8 illustrates an example comparison of reconstruction results from different poisoning functions.

FIG. 9 illustrates example reconstruction results from convolutional feature produced by featurizers with different depth.

FIG. 10 illustrates example reconstruction results for face images from the original and poisoned convolutional features.

FIG. 11 illustrates an example method for training a deep poisoning function.

FIG. 12 illustrates an example computer system.

### DESCRIPTION OF EXAMPLE EMBODIMENTS

As deep networks are applied to an ever-expanding set of tasks, protecting general privacy in data files has become a critically important goal. As an example and not by way of limitation, these tasks may be computer vision tasks and the data files may be images. The embodiments disclosed herein present a new framework for privacy-preserving data sharing that is robust to adversarial attacks and overcomes the known issues existing in previous approaches. The embodiments disclosed herein introduce the concept of a Deep Poisoning Function (DPF), which is a module inserted into a pre-trained deep network designed to perform a specific vision task. In particular embodiments, the DPF may be optimized to deliberately poison image data to prevent known adversarial attacks, while ensuring that the altered image data is functionally equivalent to the non-poisoned data for the original task. Given this equivalence, both poisoned and non-poisoned data may be used for further retraining or fine-tuning. Experimental results on image classification and face recognition tasks prove the efficacy of the embodiments disclosed herein.

In particular embodiments, a computing system may access a first machine-learning model trained to generate a feature representation of an input data. The computing system may also access a second machine-learning model trained to generate a desired result based on the feature representation. The computing system may additionally access a third machine-learning model trained to generate an undesired result based on the feature representation. In particular embodiments, the computing system may further train a fourth machine-learning model by the following process. The computing system may first generate a secured feature representation by processing a first output of the first machine-learning model using the fourth machine-learning model. The computing system may then generate a second output and a third output by processing the secured feature representation using, respectively, the second and third machine-learning models. The computing system may further update the fourth machine-learning model according to an optimization function configured to optimize a correctness of the second output and an incorrectness of the third output.

In particular embodiments, the first, second, third, and fourth machine-learning models may be each based on one or more convolutional neural networks. Deep networks have achieved state-of-the-art results on many computer vision tasks, which can be used in many critical production systems. Traditionally, training of these networks requires task-specific datasets with many images but sharing these datasets for common benchmarking may be inappropriate since they may contain sensitive or private information. For instance, most individuals would not want their faces shared in publicly-released datasets, especially without their explicit consent. To enable the sharing of image data containing sensitive content, recent proposals include preserving privacy through algorithms or gathering the explicit consent of individuals that appear in the dataset.

Although individuals may consent to appear in a dataset, sensitive information can still be inadvertently disclosed in a set of images, and an extra layer of security could help to reduce this potential for harm. Methods have been developed to protecting content within visual data, including image obfuscation and perturbation, which may reduce or remove sensitive information by altering the images themselves. Because Convolutional Neural Networks (CNNs) are widely used in image-related tasks, another strategy may be to release intermediate, convolutional features generated during the forward pass over an image (a process called image featurization). Then, as opposed to training over image-label pairs, one can train a model on feature-label pairs, and unlike images, the original image content may be usually not immediately apparent when visualizing these features. Unfortunately, both obfuscated images and featurized images may be vulnerable to reconstruction or other types of attacks, where the original image content may be revealed from the obfuscated data. To counter this, recent adversarial developments attempt to explicitly train an obfuscator to defend against such a reconstruction attack.

In particular embodiments, the input data may comprise sensitive or private information. The embodiments disclosed herein focus on methods for the general prevention of potential attacks on publicly-released convolutional features, so that image data can be shared for a particular vision task without leaking sensitive or private information. In other words, the secured feature representation may comprise none of the sensitive or private information. The embodiments disclosed herein denote the given task that the features are designed for (such as classification) as the target task and the potential attack (such as reconstruction) as the byproduct attack. For example, when convolutional features of images are publicly shared for training image classification models, the image reconstruction may restore the original images and reveal content meant to be kept private.

To achieve this, the first contribution of the embodiments disclosed herein is a training regime designed to prevent the convolutional features from a byproduct attack with a minimal loss in original target task performance. FIG. 1 illustrates an example framework for protecting intermediate convolutional features. FIG. 1 shows that these “poisoned” features may not be used to reconstruct images, but remain functionally equivalent to non-poisoned features for a given target task, such as image classification. In particular embodiments, the optimization function may be based on a deep poisoning function. As shown in FIG. 1, this is accomplished with a module denoted as the deep poisoning function (DPF). In particular embodiments, the desired result may comprise one or more of a classification of an image, a determination of an angle of a face, or a detection of a person. By contrast, the undesired result may comprise one or more of a reconstruction of an image, an identification of a face, or a racial recognition of a person. In particular embodiments, these “poisoned” features cannot be used to reconstruct images but remain functionally equivalent to non-poisoned features for a given target task, such as image classification. Specifically, the embodiments disclosed herein split a pre-trained task-specific model at a given point and use certain starting layers of the model as a featurizer to produce convolutional features. In particular embodiments, the featurizer may correspond to the first machine-learning model. Then, a straw man network may be trained on the convolutional features as a representation of a byproduct attack. In particular embodiments, the straw man network may correspond to the third machine-learning model. For instance, an image reconstructor may be trained to restore images from their feature representation. Afterwards, a DPF may be trained to disrupt the convolutional features such that the byproduct attack performance suffers, while the target task may be well preserved. The DPF may be optimized by jointly maximizing the target task objective and minimizing the byproduct objective. Therefore, the raw images may be first featurized and then poisoned to generate poisoned convolutional features for privacy-safe sharing.

The second contribution of the embodiments disclosed herein is a partial release strategy that prevent the poisoned convolutional features from the secondary attack. Since the target-task-related information and the byproduct-related information may not be mutually exclusive, the embodiments disclosed herein may assume that neither the proposed DPF nor existing approaches can completely remove byproduct-related information from convolutional features learned for the target task. In order to allow new images to be used alongside the released convolutional features, previous adversarial approaches require the release of their obfuscation method, which makes training a byproduct attack model on top of the obfuscator straightforward, denoted as a secondary attack in the embodiments disclosed herein. Instead, the proposed DPF makes the poisoned features nearly indistinguishable from the original ones from the target task's perspective (target-task equivalence), but unusable for the byproduct attack. Therefore, the trained DPF may remain private, which removes the potential for a secondary byproduct attack.

Finally, the embodiments disclosed herein conducted experiments to verify that the proposed DPF may prevent a byproduct attack on the convolutional features with a minimal loss in target task performance. Furthermore, even though the DPF is trained on only one pre-trained straw man network, it may also prevent other byproduct attack models trained on the same convolutional features but unknown during its training. The experiments demonstrate that the proposed DPF framework may be an effective way to share image data in a privacy-safe manner. It is worth noting that the embodiments disclosed herein may be applied to not only image data but any other suitable data comprising sensitive or private information. Accordingly, the input data may comprise one or more of a text, an image, an audio clip, or a video.

Recent effort on preserving data privacy may include privacy-preserving data publishing (PPDP) and privacy-preserving visual tasks. PPDP may collect a set of individual records and publish the records for further data mining, without disclosing individual attributes such as gender, disease, or salary. Existing work on PPDP mainly focuses on anonymization and data slicing. While PPDP usually handles individual records related to identification, it may be not explicitly-designed for general high-dimensional data, such as images.

Other recent work has attempted to specifically preserve privacy in images and videos. De-identification methods may partially alter images, for example by obfuscating faces. However, these approaches may be designed specifically for anonymization and may limit the re-usability of the data for a given target task. Encryption-based approaches may train models directly on encrypted data, but this may prevent general dataset release, as specialized models are required. An alternative approach may be to use super low-resolution images in order to avoid leaking sensitive information.

Most recent approaches to protect sensitive content in image data are usually obfuscation-based. Some examples may include intuitive perturbations, such as blurring and blocking, which may impair the usability of the image data, or reversible perturbations due to rich visual information. Inspired by Generative Adversarial Nets (GAN), adversarial approaches learn deep obfuscators for images or corresponding convolutional features. However, to ensure the re-usability of the learned models, the learned obfuscators may need to be released along with the image data. Thus, the obfuscated images or convolutional features may be still vulnerable to a secondary byproduct attack, as an attack model can be trained on the top of the obfuscator.

The embodiments disclosed herein use image classification as an example of the target task and image reconstruction as a potential byproduct attack. The proposed method aims to learn a DPF from the images to be shared and transform them into convolutional representations with two objectives: 1) the representation must contain the requisite information needed to train image classification models; 2) image reconstruction from the representation is not possible.

Suppose there is an image classification task to be made public, and in a privacy-safe manner, specifically by releasing both a set of convolutional features (instead of raw images), and a model that can create similar features from other images and predict labels given convolutional features as input. One reason for designing such a framework may be to avoid having to release an image dataset that may contain sensitive information, while still allowing others to use and potentially retrain models that are trained on this data. Denote the collected and annotated image set as S={x_1,x_2, . . . , x_n}. According to existing state-of-the-art CNN architectures such as VGGNet, ResNet, ResNeXt or DenseNet, an initial classification model Φ may be learned to predict image labels prior to release. In particular embodiments, the classification model may correspond to the second machine-learning model. A standard cross entropy loss function may be adopted for optimization of this target task,

[symbol]

_{T}(x,yᵢ)=−log(e^{p(Φ(x)=y}^{ᵢ}⁾)/Σⱼe^{p(Φ(x)=y}^{ⱼ}⁾, (1)

where yᵢ represents the annotation of the image x ∈ [symbol] . FIG. 2 illustrates an example initial training of a classification model and an associated reconstruction process. In FIG. 2, (a) illustrates that a CNN model learned for image classification produces intermediate convolutional features and (b) illustrates that the extracted convolutional features are used for image reconstruction. As illustrated in FIG. 2, the embodiments disclosed herein split the pre-trained image classification model into two sequential modules by setting a hook point: the featurizer φ₁ may comprise certain starting layers of the architecture until the hook point, while the classifier φ₂ may comprise the remaining layers after the hook point

Φ(x)=φ₂(φ₁(x)). (2)

The embodiments disclosed herein denote the parameters of the pre-trained image classification model as θ_{Φ}, {θ_{φ1}, θ_{φ2}}.

Based on the pre-trained featurizer, the embodiments disclosed herein extract a feature bank φ( [symbol] ). In other words, the first output may comprise at least a feature representation. The embodiments disclosed herein then release the feature bank φ₁( [symbol] ) and the pre-trained model Φ. Afterwards, the image set [symbol] is deleted. Because the original featurizer is released, others may create new convolutional features, and use the classifier to classify their own images (or even finetune it on some other dataset).

Even though the convolutional features in φ₁( [symbol] ) may not visually depict the image content, adversaries may still easily convert them to the original images by training an image reconstructor. To simulate this byproduct attack, the embodiments disclosed herein learn a straw man reconstructor ψ. Since the embodiments disclosed herein do not release the image set [symbol] publicly, the adversaries may need to use some other data, such as another public image dataset [symbol] to train the reconstruction model. For z ∈ [symbol] , the embodiments disclosed herein can train by minimizing the difference (e.g. L1 loss) between the original image [symbol] and the reconstructed image [symbol] =ψ(φ₁( [symbol] )), as shown in FIG. 2. Thus, the reconstructor ψ may learn to reverse the general featurization process, and because it may also reconstruct the image set [symbol] from the released feature bank φ₁ ( [symbol] ), this type of attack may nullify the original attempt at enforcing privacy via featurization.

To defend against the byproduct attack of reconstructing original images from the convolutional features, the embodiments disclosed herein propose a framework that applies a deep poisoning function to the convolutional features prior to release. Furthermore, the embodiments disclosed herein propose a partial release strategy to defend against a secondary byproduct attack, which learns to reconstruct poisoned convolutional features.

FIG. 3 illustrates example information contained in convolutional features. Based on the fact that the same convolutional features for an input image x can be used for different applications, the embodiments disclosed herein hypothesize that various visual information (denoted as [symbol] ) may be preserved by the convolutional features φ₁ (x). For example, convolutional features φ₁(x) may contain information both pertinent to image classification [symbol] and image reconstruction [symbol] , as shown in FIG. 3.

[37] In order to prune the information necessary for a byproduct attack from the convolutional features while preserving the information needed for the target task, the embodiments disclosed herein learn a DPF denoted as [symbol] . Conceptually, [symbol] maybe learned by optimizing

$$\begin{matrix}arg {max}_{{θ}_{P}} + arg {min}_{{θ}_{P}} ( ℛ + ) + Δ , & ( 3 ) \\ Δ ⋐ - ( ⋃ ℛ ) , & ( 4 )\end{matrix}$$

where Δ indicates the visual information not related to either task.

In this classification example, there may be two goals that the proposed DPF is designed to achieve (and defined below): classification equivalence and reconstruction disparity. If the poisoned convolutional features are equivalent to non-poisoned features from the perspective of the classifier, the poisoned features P(φ₁( [symbol] )) may be used in conjuction with features constructed from other images collected for the same task, as the featurizer may be publicly available. In other words, the second output may comprise at least a desired result based on the secured feature representation. The poisoned features themselves may be safely released because they were specifically altered to maximize the reconstruction disparity. More importantly, the obfuscating DPF may also remain private. For other tasks, such as preventing face identification in convolutional features, these goals may vary accordingly.

In particular embodiments, the first, second, third, and fourth machine-learning models may each comprise a plurality of parameters. Updating the fourth machine-learning model may comprise the following steps. The computing system may first fix the parameters of the first, second, and third machine-learning models. Then the computing system may update the parameters of the fourth machine-learning model.

Classification Equivalence The poisoning function P may be defined as an extra module inserted into the pre-trained image classification model Φ, between the featurizer φ₁ and the classifier φ₂. As shown in Eq.5, the embodiments disclosed herein require that the poisoned convolutional features perform equivalently for image classification when compared to the original convolutional features.

φ₂(P(φ₁(x)))=φ₂(φ₁(x)), P(φ₁(x))≠φ₁(x). (5)

To achieve this goal, the embodiments disclosed herein fix the parameters of the image classification model, θ_{φ1} and θ_{100 2}, and learn the poisoning function parameters θ_{P} by minimizing the classification loss in Eq.1.

Reconstruction Disparity Meanwhile, to reduce the reconstruction information in the convolutional features, the embodiments disclosed herein train the poisoning function to make the reconstructed images from the poisoned convolutional features dissimilar to the original images (in general the inverse of the byproduct-attack objective). The embodiments disclosed herein also fix the parameters of the pre-trained (or straw man) reconstructor during this step. Specifically, the embodiments disclosed herein train the DPF to ensure (ψ(P(φ₁)(x))), x), x ∈ [symbol] . To achieve this, the embodiments disclosed herein utilize the Structural Similarity Index Measure (SSIM) to quantify the reconstruction disparity, and SSIM (⋅,⋅) between two images as the loss function to optimize the poisoning function. Minimizing the SSIM decreases the similarity between two images:

[symbol]

_{B}=SSIM (ψ (P((φ₁(x))),x), x ∈ [symbol] . (6)

FIG. 4 illustrates an example training process of the deep poisoning function and associated uses cases for sharing data and pre-trained models. The top box illustrates training the deep poisoning function on the image data and use it to poison the data for release. The bottom box illustrates the following use cases of the shared data and pre-trained models. As shown in the top box of FIG. 4, the deep poisoning function is learned by jointly minimizing two loss functions. To be specific, the target function in Eq.3 would be formulated as

$${θ}_{P} = arg {min}_{{θ}_{P}} {ℒ}_{T} + λ arg {min}_{{θ}_{P}} {ℒ}_{B} \qquad ( 7 )$$

where the λ is a hyper-parameter to balance two target functions. Note that the θ_{φ1}, θ_{φ2} and θ₁₀₄ are pre-trained and remain constant during poisoning function training. In addition, this objective can be easily expanded to cover other byproduct or target tasks.

As shown in FIG. 3, the embodiments disclosed herein assume that the classification-related information and the reconstruction-related information are not mutually exclusive. Therefore, both the proposed DPF and existing adversarial methods may not completely eliminate reconstruction-related information while retaining adequate information for image classification. With the residual reconstruction-related information in the obfuscated or poisoned convolutional features, the secondary reconstructor may be further trained to restore the original images.

FIG. 5 illustrates example image reconstruction results. As an example and not by way of limitation, while existing obfuscators, such as Deep-Obfuscator (denoted as O), need to be released along with the obfuscated convolutional features to ensure the reusability of the shared data, adversaries may infer obfuscated features using public images, e.g. [symbol] ∈ [symbol] . With the pairs { [symbol] ∈ [symbol] , O ( [symbol] )}, a secondary reconstructor may be trained to restore the original images from the obfuscated convolutional features, even though the initial reconstruction is prevented, as shown in FIG. 5. In FIG. 5, (a) illustrates a raw image; (b) illustrates a reconstruction from the non-obfuscated features; (c) illustrates a reconstruction from obfuscated features by the reconstructor used in (b); and (d) illustrates a reconstruction from obfuscated features by a secondary reconstructor. To address this issue, when sharing the poisoned image data, the embodiments disclosed herein release the pre-trained featurizer φ₁, classifier φ₂ and the poisoned convolutional features P(φ₁( [symbol] )), and keep the learned deep poisoning function P as well as [symbol] in private (raw images and their original convolutional features are not shared). In particular embodiments, the computing system may access a plurality of data files. Each data file may comprise sensitive or private information. The computing system may then generate a plurality of secured feature representations of the data files by processing the data files using the first and fourth machine-learning models. In particular embodiments, the computing system may then share, to one or more third-party systems, the first, second, and third machine-learning models and the plurality of secured feature representations. The computing system may further make the plurality of data files and the fourth machine-learning model inaccessible to the one or more third-party systems.

During the poisoning function training, the parameters of the featurizer φ₁ and the classifier φ₂ are fixed to enforce the classification equivalence in Eq.5. Therefore, the poisoned convolutional features perform similarly to the non-poisoned ones for a specific classifier φ₂. If this is the case, the embodiments disclosed herein may infer that the classification-related information preserved in the poisoned features is approximate to that in the original features, ensuring that the poisoned features can be reused. For example, as shown in bottom box of FIG. 4, new classifiers, e.g. φ₃, may be trained on the poisoned convolutional features, and new images (denoted as [symbol] ), which have not been used for training classifiers, may be featurized as φ₁ ( [symbol] ) and combined with P(φ₁(S)) to refine or train classifiers, e.g. φ₂, φ₄. This may remove the need to release the DPF publicly.

By keeping the poisoning function in private, adversaries may not get pairs of image and corresponding poisoned features: specifically, 1) {x ∈ [symbol] , P (φ₁(x))}, images in [symbol] are not shared; 2) { [symbol] ∈ [symbol] , P(φ₁ ( [symbol] ))}, poisoned features for images in [symbol] may not be inferred with lacking of P. Without pairs of poisoned convolutional features and ground truth, secondary reconstructors may not be trained to attack the poisoned features, and reconstructors trained on the original features φ₁( [symbol] ) have already been disrupted by the poisoning function.

The embodiments disclosed herein conduct experiments to demonstrate that the proposed deep poisoning function may prevent a reconstruction byproduct attack on the target-task convolutional features. The first experiment is performed within an image classification framework, while the second shows qualitative results on a task designed to prevent face identification in poisoned features.

TABLE 1
Image classification results based on the original and poisoned
convolutional features by the pre-trained classifier.

Convolutional Features

| Backbone | Acc. Metric (%) | Original | Poisoned |
|---|---|---|---|
| ResNet50 | top-1 | 79.39 | 78.88 |
| | top-5 | 94.18 | 94.11 |
| ResNet101 | top-1 | 81.13 | 80.78 |
| | top-5 | 95.03 | 94.86 |

To begin with, the embodiments disclosed herein use the ImageNet dataset (i.e., a public image dataset) for the target task of image classification, and the embodiments disclosed herein require that the visual information within the convolutional features is decimated such that images reconstructed from poisoned features are illegible from a perceptual standpoint. The dataset is split into two sets, simulating a private image set, which contains sensitive information and should not be shared directly, and a public image set. The private set [symbol] contains images from a randomly selected subset of 500 ImageNet categories, while the public set [symbol] contains the remaining images. Both [symbol] and [symbol] contain training and validation subsets, which are further split among categories. Due to its general applicability for computer vision tasks, the embodiments disclosed herein adopt a ResNet architecture (i.e., a conventional convolutional neural network architecture) as the backbone network. The embodiments disclosed herein use conv[⋅]_[⋅] to represent the hook point that splits the architecture into the featurizer and the classifier. For example, conv4_1 indicates that the featurizer consists of the layers from the start of the architecture until the first building block of layer4 in the ResNet architecture.

Similar to FIG. 2, the embodiments disclosed herein train the initial image classification models, a ResNet50 (i.e., a conventional convolutional neural network architecture) and a ResNet101 (i.e., a conventional convolutional neural network architecture), on the training subset of [symbol] . The top-1 and top-5 precision for the 500-category recognition (on the validation subset of [symbol] ) achieved by the ResNet50 are 79.39% and 94.18%, respectively, while that achieved by the ResNet101 are 81.13% and 95.03%, respectively, as shown in the third column of Table 1.

Initially the embodiments disclosed herein set the hook point to conv4_1 for both models. Given an input image with dimension 224×224, the featurizer extracted from each model produces convolutional features with dimension 14×14. To simulate an attack from an adversary, the embodiments disclosed herein use the featurizer to infer convolutional features for images in image set [symbol] . Then, an image reconstructor may be trained to reverse the corresponding featurizer. The reconstructor architecture contains 2 inverse bottleneck blocks (CONV1−1−BN −CONV3×3−BN−CONV1×1−ReLU), reversing the ResNet bottleneck blocks, before upscaling the spatial dimension by a factor of 2. After several upscaling stacks, a CONV1×1−BN−ReLU−CONV1×1 module is appended to format the final output to the same dimension with the input image. A min-max normalization is utilized to limit the range of the final output to [0, 1], which is consistent with the input image range. After training, the reconstructor may restore the original images from convolutional features generated for images in both [symbol] and [symbol] . The embodiments disclosed herein use both the L1 distance and SSIM between the reconstructed images and the original images to quantify the reconstruction quality. As shown in the second and fourth columns of Table 2, the reconstructed images are highly similar to the original images.

Next, a DPF is inserted to disrupt the reconstruction-related information in the convolutional features originally learned for image classification. The DPF consists of 4 residual blocks, which are equivalent to the bottleneck blocks in the ResNet architecture, and it produces poisoned convolutional features with the same dimension as its input. Training of the deep poisoning function is conducted on the image set S (training subset) by optimizing the target function in Eq.7. The parameters in the pre-trained featurizer, classifier and reconstructor are all fixed during DPF training, and the hyper-parameter A is set to 1.0.

As shown in the last column of Table 1, the classification performance based on the poisoned convolutional features are quite close to that based on the original convolutional features. Meanwhile, the similarity between the reconstructed images and the original images is significantly reduced by the DPF, as shown in Table 2 (the third and fifth columns). FIG. 6 illustrates example comparisons of image reconstruction from the original convolutional features and the poisoned convolutional features. In FIG. 6, the second and fourth rows show image reconstruction from the original convolutional features whereas the third and fifth rows show image reconstruction from the poisoned convolutional features. These results demonstrate that the proposed poisoning function may learn to preserve the classification-related information and suppress the reconstruction-related information in the convolutional features.

TABLE 2
Reconstruction results with and without poisoning.

| | |
|---|---|
| L1 Distance (↑) | SSIM (↓) |

| conv4_1 | Original | Poisoned | Original | Poisoned |
|---|---|---|---|---|
| ResNet50 | 0.0443 | 0.2928 | 0.6730 | 0.0070 |
| ResNet101 | 0.0406 | 0.2886 | 0.7009 | 0.0069 |

Beyond this initial proof of concept, the embodiments disclosed herein conduct an ablation study to understand the proposed framework in-depth.

Various Reconstructors: The proposed DPF is learned based on a pre-trained image reconstructor and defends this specific reconstructor effectively as shown in FIG. 6. However, as its name implies, this straw man network may be an easy objective to optimize against, and in practice, there may be different adversaries designing multiple networks to reconstruct convolutional features. To verify that the proposed DPF may also defend the image reconstruction from different reconstructors (which have never been observed during the DPF training), the embodiments disclosed herein train five reconstructors for the same featurizer, conv4_1 (ResNet101), based on different architectures. The embodiments disclosed herein denote the reconstructor used for DPF training as px₂s₂, where p indicates the type of blocks used for building the reconstructor—in this case, a plain inverse bottleneck block without residual operation, with x₂ representing two blocks before upscaling, and s₂ representing that the upscaling factor is 2. Similarly, other reconstructors unknown to DPF training are denoted as px₄s₂, rx₂s₂, rx₄s₂, rx₄s₄ and rx₂s₂_c, where r indicates inverse residual bottleneck blocks, and _c means the normalization strategy during reconstructor training is clamp instead of min-max normalization. These reconstructors are learned from the image set [symbol] by following similar training procedures for training px₂s₂. FIG. 7 illustrates example reconstruction results from the original and poisoned convolutional features by reconstructors. Specifically, (a) indicates the raw images; (b) indicates reconstruction from the original (left column) and poisoned (right column) convolutional features using px2s2; (c) indicates reconstruction from the original (left column) and poisoned (right column) convolutional features using px4s2; (d) indicates reconstruction from the original (left column) and poisoned (right column) convolutional features using rx2s2; (e) indicates reconstruction from the original (left column) and poisoned (right column) convolutional features using rx4s2; (f) indicates reconstruction from the original (left column) and poisoned (right column) convolutional features using rx4s4; and (g) indicates reconstruction from the original (left column) and poisoned (right column) convolutional features using rx2s2_c. The embodiments disclosed herein feed the features produced by φ₁ and their corresponding poisoned features created with P to each of the above reconstructors and show the reconstruction results in FIG. 7. The comparisons indicate that the learned DPF may defend the reconstructors that have never been observed during its training.

Stationary v.s. Deep Poisoning Functions: The proposed DPF is learned, which means that it is possible to simultaneously ensure classification equivalence and reconstruction disparity. To justify a trained function, the embodiments disclosed herein compare it to unlearned perturbation methods, defined as stationary poisoning functions (SPFs), such as Gaussian or mean filters (GF, MF), or additive Gaussian noise (GN). FIG. 8 illustrates an example comparison of reconstruction results from different poisoning functions. By replacing the DPF with an SPF based on the proposed framework in FIG. 4 (top box), the reconstruction-related information in the convolutional features is still suppressed, but the classification-related information is also seriously impaired. For example, as shown in Table 3, when a Gaussian filter is applied to the convolutional features, image reconstruction is prevented—the L1 distance increases from 0.0406 to 0.1055 and SSIM decreases from 0.7099 to 0.4699. However, the classification performance is also diminished, as the top-1 precision drops from 81.13% to an unacceptably-low 15.60%.

Then, the embodiments disclosed herein combine the proposed DPF with the SPF to poison the convolutional features—an SPF is applied on the top of the featurizer, prior to the DPF. As shown in Table 3, combining an SPF and a DPF better prevents image reconstruction at the loss of some classification accuracy.

Featurizer Depth: The previous experiments are conducted based on setting the hook point to conv4-1 of ResNet architectures. Given an image classification model, different hook points result in different featurizers. When an early hook point is selected, the featurizer (with a relatively shallow depth) produces convolutional features that preserve more visual details of the input image. To explore the influence of featurizer depth, the embodiments disclosed herein learn an individual reconstructor and a DPF for hook points that are set at varying depths of the given ResNet. FIG. 9 illustrates example reconstruction results from convolutional feature produced by featurizers with different depth. Specifically, the embodiments disclosed herein test hook points at conv2_1, conv2_3, conv3_1, conv4_1 for a ResNet101. For an input image with size 224×224, the convolutional features produced by the featurizers ending at these hook points have dimensions of 56×56, 56×56, 28×28, and 14×14, respectively. The quantitative and qualitative results in Table 4 and FIG.9 verify that varying the hook point gives a slight tradeoff between classification accuracy and reconstruction disparity, while still achieving consistent poisoning results.

TABLE 3
Comparison of results from SPF, DPF and combinations of them.

| | |
|---|---|
| classification (%) | reconstruction |

| Poisoning | top-1 | top-5 | L1 | SSIM |
|---|---|---|---|---|
| w/o | 81.13 | 95.03 | 0.0406 | 0.7009 |
| GN | 25.47 | 45.99 | 0.1905 | 0.2635 |
| GF | 15.60 | 30.24 | 0.1055 | 0.4699 |
| MF | 4.44 | 10.78 | 0.1169 | 0.4334 |
| DPF | 80.78 | 94.86 | 0.2886 | 0.0069 |
| GN + DPF | 78.10 | 93.64 | 0.3339 | 0.0047 |
| GF + DPF | 78.77 | 93.78 | 0.3450 | 0.0041 |
| MF + DPF | 71.23 | 89.96 | 0.3564 | 0.0186 |

TABLE 4
Results of DPF on different featurizer depths. Reconstruction values:
left from features without poisoning; right - from the poisoned features.

| | Classification | | Reconstruction | |
|---|---|---|---|---|
| | top-1 | top-5 | L1 | SSIM |
| raw image | 81.13 | 95.04 | — | — |
| conv2_1 | 80.96 | 95.04 | 0.0251/0.3982 | 0.8562/0.0124 |
| conv2_3 | 81.02 | 94.97 | 0.0252/0.3688 | 0.8499/0.0151 |
| conv3_1 | 80.91 | 94.86 | 0.0299/0.2204 | 0.8048/0.0097 |
| conv4_1 | 80.78 | 94.86 | 0.0406/0.2886 | 0.7009/0.0069 |

FIG. 10 illustrates example reconstruction results for face images from the original and poisoned convolutional features. Finally, to further analyze the generalizability of DPFs to protect against other forms of byproduct attacks, the embodiments disclosed herein study how well a poisoning function inserted into a regression model may defend against face identification trained on the convolutional features. The embodiments disclosed herein train a ResNet18 model to predict the pose (roll, pitch, and yaw) of an aligned input face taken from the VGGFace2 dataset (i.e., a public face dataset). Then for the byproduct attack, the embodiments disclosed herein train another face-identification ResNet18 model on the convolutional features produced at hook point conv4_1, using 500 randomly selected identities as target classes. Instead of directly optimizing the DPF with - [symbol] _{B}, the embodiments disclosed herein set the target label for the face classification network to a random value, thus producing poisoned features that “confuse” the face identification network. The embodiments disclosed herein also train a reconstruction model on the original features in order to visualize the effects of feature poisoning. Note that this network is not used when training the DPF. In FIG. 10, columns (a) depict the original faces; columns (b) depict the reconstruction from the original convolutional features; and columns (c) depict the reconstruction from the poisoned features. The reconstruction results in FIG. 10 verify that DPF poisons the convolutional features for face identification as individually-identifying features are automatically removed from the poisoned convolutional features by the DPF.

The embodiments disclosed herein introduce the concept of a Deep Poisoning Function (DPF) that, when applied to convolutional features learned for a specific target vision task, enables the privacy-safe sharing of image data. The proposed DPF poisons convolutional features to disrupt byproduct-related information, while remaining functionally equivalent to the original convolutional features when used for the target task. The partial release strategy further ensures that the shared convolutional features cannot be reconstructed by a secondary attack on a released obfuscation function. Finally, the experiments demonstrate that the embodiments disclosed herein are effective in protecting privacy in publicly-released image data.

FIG. 11 illustrates an example method 1100 for training a deep poisoning function. The method may begin at step 1110, where the computing system 140 may access a first machine-learning model trained to generate a feature representation of an input data, a second machine-learning model trained to generate a desired result based on the feature representation, and a third machine-learning model trained to generate an undesired result based on the feature representation. At step 1120, the computing system 140 may train a fourth machine-learning model. The training may comprise the following sub-steps. At sub-step 1122, the computing system 140 may generate a secured feature representation by processing a first output of the first machine-learning model using the fourth machine-learning model. At sub-step 1124, the computing system 140 may generate a second output and a third output by processing the secured feature representation using, respectively, the second and third machine-learning models. At sub-step 1126, the computing system 140 may update the fourth machine-learning model according to an optimization function configured to optimize a correctness of the second output and an incorrectness of the third output. Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for training a deep poisoning function including the particular steps of the method of FIG. 11, this disclosure contemplates any suitable method for training a deep poisoning function including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

FIG. 12 illustrates an example computer system 1200. In particular embodiments, one or more computer systems 1200 perform one or more steps of one or more methods described or illustrated herein. In particular embodiments, one or more computer systems 1200 provide functionality described or illustrated herein. In particular embodiments, software running on one or more computer systems 1200 performs one or more steps of one or more methods described or illustrated herein or provides functionality described or illustrated herein. Particular embodiments include one or more portions of one or more computer systems 1200. Herein, reference to a computer system may encompass a computing device, and vice versa, where appropriate. Moreover, reference to a computer system may encompass one or more computer systems, where appropriate.

This disclosure contemplates any suitable number of computer systems 1200. This disclosure contemplates computer system 1200 taking any suitable physical form. As example and not by way of limitation, computer system 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1200 may include one or more computer systems 1200; be unitary or distributed; span multiple locations; span multiple machines; span multiple data centers; or reside in a cloud, which may include one or more cloud components in one or more networks. Where appropriate, one or more computer systems 1200 may perform without substantial spatial or temporal limitation one or more steps of one or more methods described or illustrated herein. As an example and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In particular embodiments, computer system 1200 includes a processor 1202, memory 1204, storage 1206, an input/output (I/O) interface 1208, a communication interface 1210, and a bus 1212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage 1206; decode and execute them; and then write one or more results to an internal register, an internal cache, memory 1204, or storage 1206. In particular embodiments, processor 1202 may include one or more internal caches for data, instructions, or addresses. This disclosure contemplates processor 1202 including any suitable number of any suitable internal caches, where appropriate. As an example and not by way of limitation, processor 1202 may include one or more instruction caches, one or more data caches, and one or more translation lookaside buffers (TLBs). Instructions in the instruction caches may be copies of instructions in memory 1204 or storage 1206, and the instruction caches may speed up retrieval of those instructions by processor 1202. Data in the data caches may be copies of data in memory 1204 or storage 1206 for instructions executing at processor 1202 to operate on; the results of previous instructions executed at processor 1202 for access by subsequent instructions executing at processor 1202 or for writing to memory 1204 or storage 1206; or other suitable data. The data caches may speed up read or write operations by processor 1202. The TLBs may speed up virtual-address translation for processor 1202. In particular embodiments, processor 1202 may include one or more internal registers for data, instructions, or addresses. This disclosure contemplates processor 1202 including any suitable number of any suitable internal registers, where appropriate. Where appropriate, processor 1202 may include one or more arithmetic logic units (ALUs); be a multi-core processor; or include one or more processors 1202. Although this disclosure describes and illustrates a particular processor, this disclosure contemplates any suitable processor.

In particular embodiments, memory 1204 includes main memory for storing instructions for processor 1202 to execute or data for processor 1202 to operate on. As an example and not by way of limitation, computer system 1200 may load instructions from storage 1206 or another source (such as, for example, another computer system 1200) to memory 1204. Processor 1202 may then load the instructions from memory 1204 to an internal register or internal cache. To execute the instructions, processor 1202 may retrieve the instructions from the internal register or internal cache and decode them. During or after execution of the instructions, processor 1202 may write one or more results (which may be intermediate or final results) to the internal register or internal cache. Processor 1202 may then write one or more of those results to memory 1204. In particular embodiments, processor 1202 executes only instructions in one or more internal registers or internal caches or in memory 1204 (as opposed to storage 1206 or elsewhere) and operates only on data in one or more internal registers or internal caches or in memory 1204 (as opposed to storage 1206 or elsewhere). One or more memory buses (which may each include an address bus and a data bus) may couple processor 1202 to memory 1204. Bus 1212 may include one or more memory buses, as described below. In particular embodiments, one or more memory management units (MMUs) reside between processor 1202 and memory 1204 and facilitate accesses to memory 1204 requested by processor 1202. In particular embodiments, memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1204 may include one or more memories 1204, where appropriate. Although this disclosure describes and illustrates particular memory, this disclosure contemplates any suitable memory.

In particular embodiments, storage 1206 includes mass storage for data or instructions. As an example and not by way of limitation, storage 1206 may include a hard disk drive (HDD), a floppy disk drive, flash memory, an optical disc, a magneto-optical disc, magnetic tape, or a Universal Serial Bus (USB) drive or a combination of two or more of these. Storage 1206 may include removable or non-removable (or fixed) media, where appropriate. Storage 1206 may be internal or external to computer system 1200, where appropriate. In particular embodiments, storage 1206 is non-volatile, solid-state memory. In particular embodiments, storage 1206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1206 taking any suitable physical form. Storage 1206 may include one or more storage control units facilitating communication between processor 1202 and storage 1206, where appropriate. Where appropriate, storage 1206 may include one or more storages 1206. Although this disclosure describes and illustrates particular storage, this disclosure contemplates any suitable storage.

In particular embodiments, I/O interface 1208 includes hardware, software, or both, providing one or more interfaces for communication between computer system 1200 and one or more I/O devices. Computer system 1200 may include one or more of these I/O devices, where appropriate. One or more of these I/O devices may enable communication between a person and computer system 1200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1208 for them. Where appropriate, I/O interface 1208 may include one or more device or software drivers enabling processor 1202 to drive one or more of these I/O devices. I/O interface 1208 may include one or more I/O interfaces 1208, where appropriate. Although this disclosure describes and illustrates a particular I/O interface, this disclosure contemplates any suitable I/O interface.

In particular embodiments, communication interface 1210 includes hardware, software, or both providing one or more interfaces for communication (such as, for example, packet-based communication) between computer system 1200 and one or more other computer systems 1200 or one or more networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1210 for it. As an example and not by way of limitation, computer system 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1200 may include any suitable communication interface 1210 for any of these networks, where appropriate. Communication interface 1210 may include one or more communication interfaces 1210, where appropriate. Although this disclosure describes and illustrates a particular communication interface, this disclosure contemplates any suitable communication interface.

In particular embodiments, bus 1212 includes hardware, software, or both coupling components of computer system 1200 to each other. As an example and not by way of limitation, bus 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1212 may include one or more buses 1212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
accessing:
a first machine-learning model trained to generate a feature representation of an input data;
a second machine-learning model trained to generate a desired result based on the feature representation; and
a third machine-learning model trained to generate an undesired result based on the feature representation; and
training a fourth machine-learning model by:
generating a secured feature representation by processing a first output of the first machine-learning model using the fourth machine-learning model;
generating a second output and a third output by processing the secured feature representation using, respectively, the second and third machine-learning models; and
updating the fourth machine-learning model according to an optimization function configured to optimize a correctness of the second output and an incorrectness of the third output.

2. The method of claim 1, wherein the input data comprises one or more of a text, an image, an audio clip, or a video.

3. The method of claim 1, wherein the first, second, third, and fourth machine-learning models are each based on one or more convolutional neural networks.

4. The method of claim 1, wherein the desired result comprises one or more of a classification of an image, a determination of an angle of a face, or a detection of a person.

5. The method of claim 1, wherein the undesired result comprises one or more of a reconstruction of an image, an identification of a face, or a racial recognition of a person.

6. The method of claim 1, wherein the input data comprises sensitive or private information, and wherein the secured feature representation comprises none of the sensitive or private information.

7. The method of claim 1, wherein the first output comprises at least a feature representation.

8. The method of claim 1, wherein the second output comprises at least a desired result based on the secured feature representation.

9. The method of claim 1, wherein the optimization function is based on a deep poisoning function.

10. The method of claim 1, wherein the first, second, third, and fourth machine-learning models each comprise a plurality of parameters, and wherein updating the fourth machine-learning model comprises:
fixing the parameters of the first, second, and third machine-learning models; and
updating the parameters of the fourth machine-learning model.

11. The method of claim 1, further comprising:
accessing a plurality of data files, each data file comprising sensitive or private information; and
generating a plurality of secured feature representations of the data files by processing the data files using the first and fourth machine-learning models.

12. The method of claim 11, further comprising:
sharing, to one or more third-party systems, the first, second, and third machine-learning models and the plurality of secured feature representations; and
making the plurality of data files and the fourth machine-learning model inaccessible to the one or more third-party systems.

13. One or more computer-readable non-transitory storage media embodying software that is operable when executed to:
access:
a first machine-learning model trained to generate a feature representation of an input data;
a second machine-learning model trained to generate a desired result based on the feature representation; and
a third machine-learning model trained to generate an undesired result based on the feature representation; and
train a fourth machine-learning model by:
generating a secured feature representation by processing a first output of the first machine-learning model using the fourth machine-learning model;
generating a second output and a third output by processing the secured feature representation using, respectively, the second and third machine-learning models; and
updating the fourth machine-learning model according to an optimization function configured to optimize a correctness of the second output and an incorrectness of the third output.

14. The media of claim 13, wherein the input data comprises one or more of a text, an image, an audio clip, or a video.

15. The media of claim 13, wherein the first, second, third, and fourth machine-learning models are each based on one or more convolutional neural networks.

16. The media of claim 13, wherein the desired result comprises one or more of a classification of an image, a determination of an angle of a face, or a detection of a person.

17. The media of claim 13, wherein the undesired result comprises one or more of a reconstruction of an image, an identification of a face, or a racial recognition of a person.

18. The media of claim 13, wherein the input data comprises sensitive or private information, and wherein the secured feature representation comprises none of the sensitive or private information.

19. The media of claim 13, wherein the optimization function is based on a deep poisoning function.

20. A system comprising: one or more processors; and a non-transitory memory coupled to the processors comprising instructions executable by the processors, the processors operable when executing the instructions to:
access:
a first machine-learning model trained to generate a feature representation of an input data;
a second machine-learning model trained to generate a desired result based on the feature representation; and
a third machine-learning model trained to generate an undesired result based on the feature representation; and
train a fourth machine-learning model by:
generating a secured feature representation by processing a first output of the first machine-learning model using the fourth machine-learning model;
generating a second output and a third output by processing the secured feature representation using, respectively, the second and third machine-learning models; and
updating the fourth machine-learning model according to an optimization function configured to optimize a correctness of the second output and an incorrectness of the third output.
